(19) United States
(12) Patent Application Publication
(10) Pub. No.: US 2008/0303748 A1
(43) Pub. Date: Dec. 11, 2008

(54) REMOTE VIEWING AND MULTI-USER PARTICIPATION FOR PROJECTIONS

(75) Inventor: Kedar B. Borhade, Redmond, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/758,803

(22) Filed: Jun. 6, 2007

(51) Int. Cl. G09G 5/00

(52) U.S. Cl. 345/2.2

(57) ABSTRACT

Members of a presentation audience can make changes to digital visual aids from remote locations. This can take place through rendering images of the digital visual aids at a projection site. A participant device can send a signal to a host device to modify the digital visual aid. Furthermore, an audience member can take notes on an interactive local copy of the digital visual aids.

### TECHNICAL FIELD

The subject specification relates generally to information display and in particular to rendering of information by a projector.

### BACKGROUND

Meetings are a common form of communicating information to a relatively large number of individuals. A speaker or group of speakers performs a presentation to an audience. A classical meeting uses a configuration of the speaker and audience members in a single room where the speaker can be assisted with supports (e.g., charts, musical sounds, etc.) or an enhancement product (e.g., microphone system, overhead magnifier, etc.) Meeting members travel from different locations to congregate in the same location.

Recent technological developments influence how meetings are conducted. For example, teleconferencing capabilities allow parties to interact without needing to be physically together. Teleconferencing interconnects phone lines so multiples lines can take part in the same conversation. Digital technology developments improve teleconferences by providing greater clarity conversations as well as increased amounts of information transfer.

The recent technological developments increase the efficiency and cost effectiveness of presentations. Teleconferences allow individuals to participate without leaving their home or office. An individual can have access to greater resources then if they had traveled to a physical site. This can both include the addition of a physical resource (e.g., accessing a desktop computer) as well as addition of a human resource (e.g., including an expert on a topic on short notice). Furthermore, there are auxiliary costs associated with a physical meeting that are eliminated by utilization of technological developments. For example, teleconferences can eliminate a need for expenditure of transportation costs, food, lodging, overtime pay, and work productivity lost from traveling.

### SUMMARY

The following presents a simplified summary of the specification in order to provide a basic understanding of some aspects of the specification. This summary is not an extensive overview of the specification. It is intended to neither identify key or critical elements of the specification nor delineate the scope of the specification. Its sole purpose is to present some concepts of the specification in a simplified form as a prelude to the more detailed description that is presented later.

Conventional presentations can employ a presenter that uses a computer presentation application to disseminate information to a relatively large group of viewers. However, there are several limitations in conventional presentations. It can be difficult for a viewer to take notes during a presentation that relates to aids utilized in the presentation. Furthermore, computer presentation applications are often relatively static which does encourage interaction between a presenter and a participant.

The subject specification allows an audience member to take notes during a dynamic presentation. An audience member can interact with an electronic device (e.g., a laptop tablet computer) that integrates with a projector where projected visual aids are displayed on the electronic device. The audience member can take notes on visual aids (e.g., digital slides) through the electronic device. If the visual aids change during the presentation, then the visual aids change on the electronic device.

In addition, the subject specification allows audience members to make real-time changes to visual aids of a presentation. An audience member can engage an electronic device in order to propose a change to a visual aid. The electronic device transmits a proposed change, a host device can authorize the change, and members of the audience view the change. Furthermore, the change can be implemented on the electronic devices of other members of the audience.

To assist in the real-time changes, image rendering takes place on a projection side of a presentation, while conventional image rendering takes place on a host side. An application receives information from a user and a driver transfers model information from the application to the projector. The projector renders the information into an image and the image is displayed.

The following description and the annexed drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

FIG. 1 illustrates a representative presentation system in accordance with an aspect of the subject specification.

FIG. 2 illustrates a representative presentation system in accordance with an aspect of the subject specification.

FIG. 3 illustrates a representative host in accordance with an aspect of the subject specification.

FIG. 4 illustrates a representative projector system in accordance with an aspect of the subject specification.

FIG. 5a illustrates a representative unmodified slide in accordance with an aspect of the subject specification.

FIG. 5b illustrates a representative modified slide in accordance with an aspect of the subject specification.

FIG. 6a illustrates a representative unmodified slide in accordance with an aspect of the subject specification.

FIG. 6b illustrates a representative modified slide in accordance with an aspect of the subject specification.

FIG. 7 illustrates a representative audience member device in accordance with an aspect of the subject specification,

FIG. 8 illustrates a representative rendering methodology in accordance with an aspect of the subject specification.

FIG. 9 illustrates a representative local image methodology in accordance with an aspect of the subject specification.

FIG. 10 illustrates a representative host operation methodology in accordance with an aspect of the subject specification.

FIG. 11 illustrates an example of a schematic block diagram of a computing environment in accordance with the subject specification.

FIG. 12 illustrates an example of a block diagram of a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “module,” “system”, “interface”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. As another example, an interface can include I/O components as well as associated processor, application, and/or API components.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

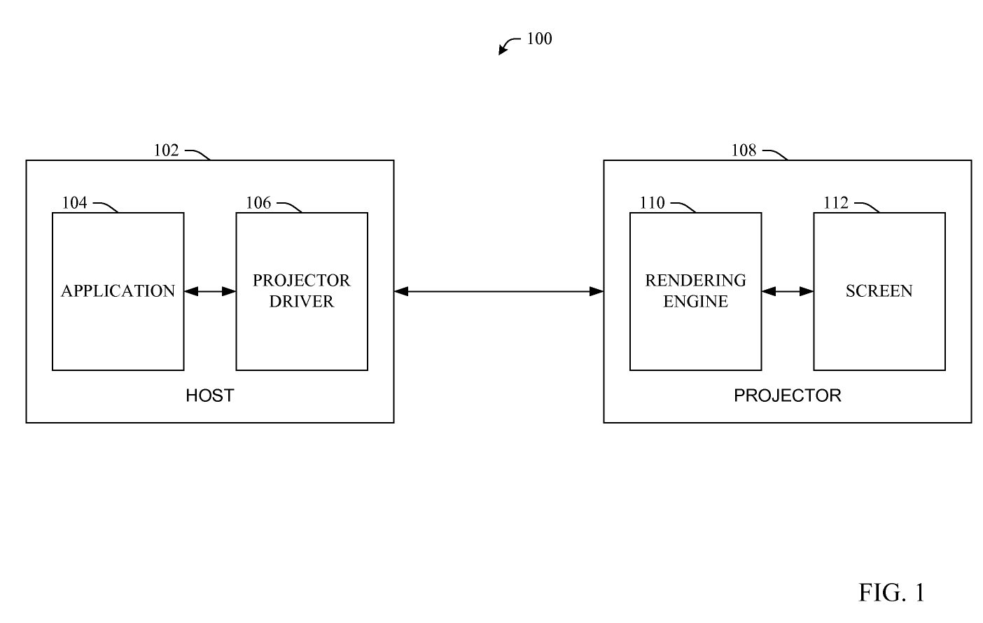

FIG. 1 discloses an example system 100 implementing various aspects disclosed in the subject specification. At a host 102, an application 104 operates in conjunction with a projector driver 106 for use in a presentation. For example, the host 102 can be a laptop computer that contains information related to a presentation. Ultimately, the host 102 communicates presentation information to a projector 108, where the projector 108 presents information to an audience.

The application 104 holds and creates a presentation that will be used by a speaker. For example, the application 104 can have a number of slides that can be filtered through during the presentation. Furthermore, the application 104 can include features that prepare the presentation for rendering upon the projector 108. For example, the application can include a capability to encrypt the presentation prior to exiting the host 102. In addition, there can be information on how to decrypt the presentation that can be understood by a rendering engine.

The project driver 106 allows for data transfer between the host 102 and the projector 108. According to one embodiment, the projector driver 108 emits the information to a specific projector 108. According to another embodiment, the project driver emits information from the application without a specific intended final location. A projector 108 or multiple projectors 108 can retrieve what was emitted by project driver 106. This can operate in a similar manner to a radio receiving what is sent over a specific frequency.

The projector 108 can operate as a rendering device (e.g., on the device side). A rendering engine 110 furnishes information that is to be displayed on a screen 112. The rendering engine takes application information that was emitted by the host 102 and presents it upon a screen 112. The screen 112 can be a range of items; for example, the screen 112 can be an integrated display, a wall, a bed sheet, etc. While the screen 112 is disclosed as being part of the projector 108, it is to be appreciated that the screen 112 can be a separate component and the projector 108 can represent one side of a system 100 without components connecting together.

Rendering information on the device side allows for multiple benefits. One benefit is there is minimal data transfer for screen updates. For example, a pointer on the screen 112 can have an instruction to move and this would require an update on the screen 112. Since the projector 108 is performing the rendering, there does not need to be a large amount of data transfer between the host and the projector.

Furthermore, there can be multiple user participation. Since the projector 108 performs the rendering, participants can change information displayed on the screen 112. Furthermore, the physical screen can be split and thus showing two visuals at one. For example, charts describing two approaches to the allocation of funds can be displayed on the same screen 112 to provide a direct comparison. This can take place when the approaches derive from different hosts.

In addition, since rendering is performed on the projection side, there can be data optimization for optimal performance. Since many resources are local (e.g., on the device side), calculations can take place at a faster speed and more can be known about the data to be projected since it is rendered and projected at one location. In addition, the screen 112 should persist until the screen 112 is invalidated through reducing a bandwidth requirement.

For example, a presenter enters a conference center with a host 102. The presenter engages the host 102 by searches for a projector 108 and connecting with the projector 108. In a manner that can be similar to printing, slides are rendered one at a time. According to one embodiment, in order to conserve battery life, the host 102 can enter a sleep mode once an individual slide is sent. However, there are instances where entering a sleep mode is not practical. For example, the projector 108 could benefit from a continuous connection with the host 102; therefore, the host 102 should not go into a sleep mode.

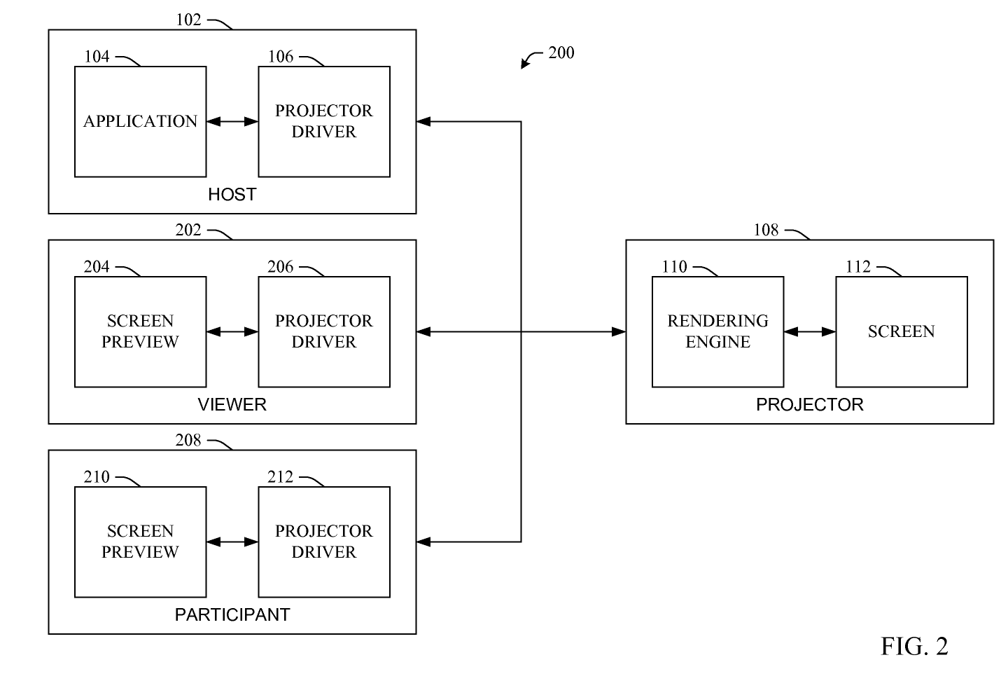

FIG. 2 discloses an example system 200 where there are multiple parties taking part in a single conference. A host 102 operates in conjunction with an application 104 and a projector driver 106. Furthermore, a projector 108 operates with a rendering engine 110 and a screen 112. The specific operation characteristics of the host 102 and the projector 108, as well as related components, are described in FIG. 1. However, it is possible these there be variations concerning the characteristics.

A viewer 202 is used by a user that is in an audience of a presentation that cannot change what is present on the screen 112. The viewer 202 can have an integrated screen preview 204 that displays information located on the screen 112. The user can contain a local copy of what is displayed on the screen through a projector driver 206. The local copy can be changed and modified based on a user's desire to take notes on the presentation.

In a conventional presentation, a physical paper copy of the presentation aids is provided to a user. The user can take notes on the paper, but it can be difficult to create a digital copy. For example, the user would need to find a high-performance scanner with the capability of capturing the notes. In another conventional presentation, the user is provided with a digital copy of the presentation aids (e.g., aids created through an application). However, the digital copy does not allow for the capture of changes that take place to aids during a presentation.

A participant 208 is utilized by a user that is in the audience of the presentation that can change what is present on the screen. Capabilities of the participant 208 commonly include capabilities of the viewer 202 (e.g., creation of notes on a local copy of presentation aids) as well as additional capabilities. However, the participant 208 can change what is displayed on the screen 112 and thus other related components (e.g., the screen preview 204 of the viewer 202). A user can view information pertaining to the presentation from a screen preview 210 integrated into the participant 208. The participant 208 receives an instruction for a change and a projector driver 212 transmits the instruction.

In operation, the participant 208 receives a command from a user to change information displayed on the screen 112 and thus information shown on the screen preview 210. Through the projector driver 212, the participant attempts to make a requested change. According to one embodiment, the participant 208 waits for permission form the host 102 to make a change. Permission can be granted through internal logic or a request can be made to a user working with the host 102 (e.g., speaker) to grant or deny the request. According to another embodiment, the participant can automatically make a change without waiting for permission from the host.

The system 200 can operate according to a number of different embodiments. According to one embodiment, the host 102, viewer 202, participant 208 and projector 108 are located in the same physical space (e.g., in the same room). According to another embodiment, the system 200 is transferred throughout a building or campus where different components (e.g., host 102, projector 108, etc.) are in different locations. According to yet a further embodiment, the system 200 implements virtually where there is not physical connection between components (e.g., the system 200 operates wirelessly.)

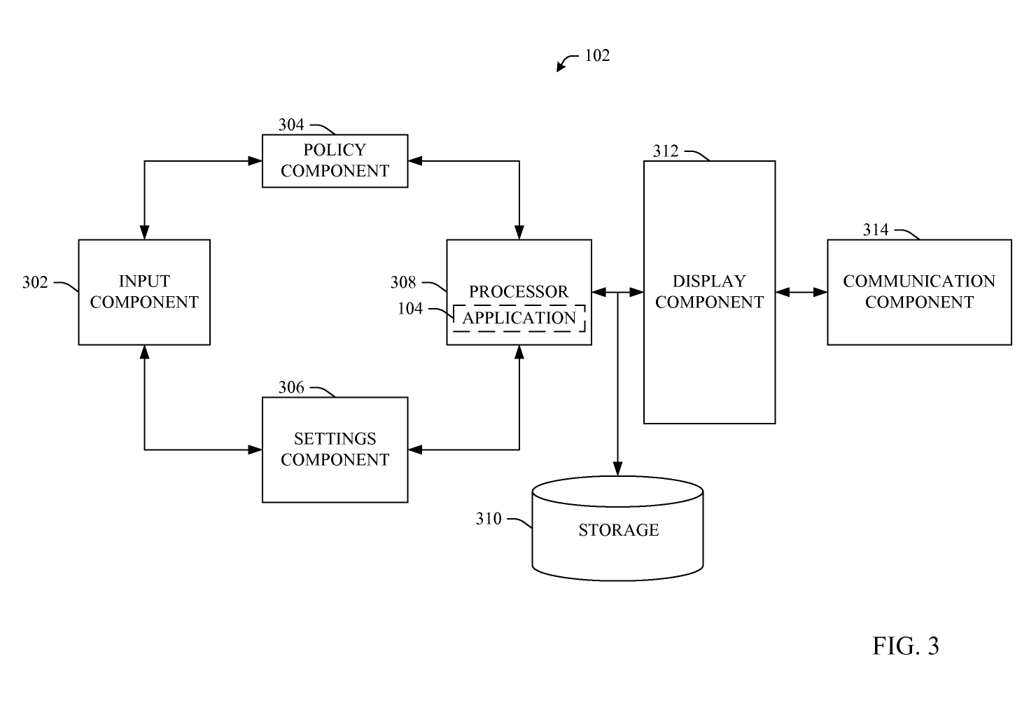

FIG. 3 discloses an example host 102 as disclosed in the subject specification. An input component 302 obtains information from a user, commonly a speaker and/or presenter. According to one embodiment, the input component 302 is a keyboard that allows a user to input information directly into the host 102. According to another embodiment, the input component 302 is a universal serial bus (USB) port that can receive a device that includes at least one digital visual aid. According to yet another embodiment, the input component 302 is capable of communicating wirelessly with an auxiliary device, where the auxiliary device can input information into the host 102 through the input component 302.

A policy component 304 operates upon information from a presenter as to how audience members can interact with the displayed information. One aspect of the policy component 304 regulates policies concerning the ability of audience members to use digital visual aids for note taking purposes. For example, a presenter could want to restrict distribution of digital visual aids. Therefore, the policy component can restrict the distribution of materials. This can be a complete restriction (e.g., no one can access the materials), a selective restriction (e.g., certain parties can access the materials), a temporal restriction (e.g., the first ten people to access the materials receive the materials, subsequent requestors are denied), etc.

Another aspect of the policy component 304 regulates the capabilities of audience members to modify digital visual aids. The policy component 304 can stop parties from modifying presented aids. There can be various implementations by the policy component 304. For example, the policy component 304 can allow for modification of some slides of a visual presentation, but not others.

Furthermore, the policy component 304 can regulate different requests from different audience members. For example, the policy component 304 can automatically allow one audience member to change the materials, require a second audience member to seek permission, and automatically reject a third audience member. It is to be appreciated that while the policy component 304 is depicted as part of the host 102, it can function alone or integrate into other devices (e.g., integrate into the projector 108 of FIG. 2.)

A setting component 306 operates information regarding the operation of the host 102. The settings component 306 can receive user input through the input component 302 concerning operation of devices pertaining to the system 200 of FIG. 2. Settings can include the resolution of displayed information, the time of presentment for slides in a presentation, etc.

A processor 308 coordinates functions of the host 102. Various amounts of information can enter and exit the projector 102 and the processor 308 operates to assure that information executes in a proper manner. While the processor 308 is shown as directly interacting with several components, it is to be appreciated the processor 308 can interact with different component configurations (e.g., interaction with all disclosed components.) According to one embodiment, the processor 308 can operate as the projector driver 106 of FIG. 2. The processor 308 can utilize internal logic to determine when to place specific components into a sleep mode.

The processor 308 can be embedded with the application 108. The application 108 can be a computer program that engages a user to create a visual display for a presentation. For example, the application 104 can gather information from storage 310 and operate in conjunction with the processor 308. The processor 308 in coordination with the application 104 can prepare model information to be transmitted to the projector 108 of FIG. 2.

The storage 310 can be a medium that can hold digital information and store records concerning the host 102. For example, the storage can hold a record concerning information sent from the host 102 to the projector 108. Furthermore, the storage can be utilized by other components of the host 102. For example, created policies and settings can be saved in the storage 310.

The display component 312 can present information to a user engaged in with the host 102. For example, the display component 312 can present to the user model information that can be rendered by the projector 108 of FIG. 2. It is to be appreciated that the host 102 can include a rendering component that allows an image to be viewed locally.

A communication component 314 can transmit information from the host 102 to other devices, including the projector 108 of FIG. 2. The communication component 314 can operate wirelessly or through a hardwire connection. Furthermore, the input component 302 and the communication component 314 can integrate together to form one components. The communication component 314 can also transmit information to the projector 108 of FIG. 2 concerning the implementation of policies and/or settings. The communication component 314 can be utilized to search for a projector 108 of FIG. 2 that can receive model information.

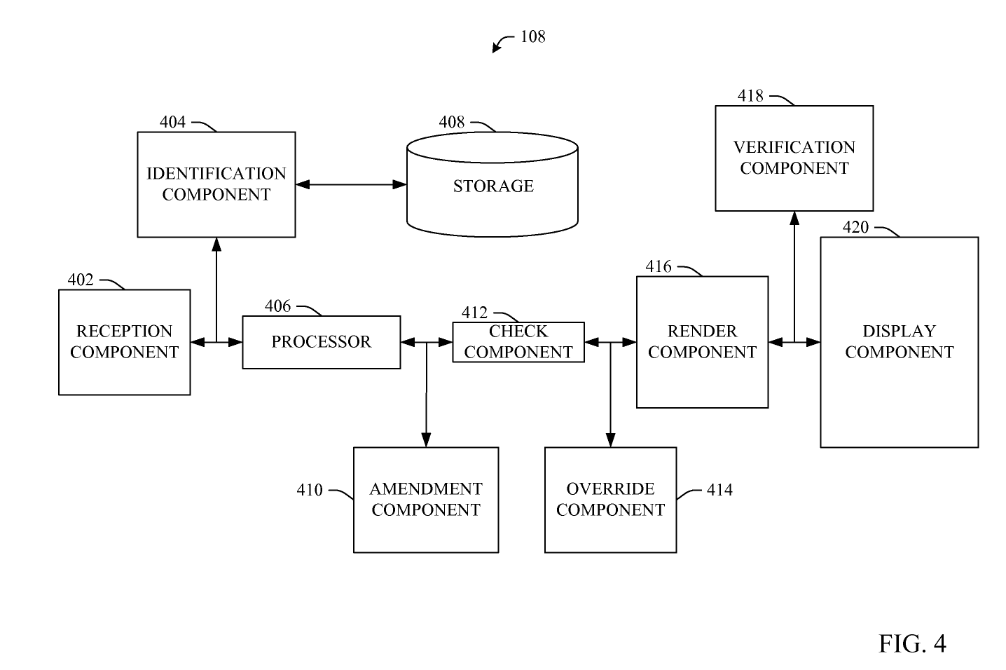

FIG. 4 discloses an example projector 108 as disclosed in the subject specification. A reception component 402 receives information for presentment. Received information can be from a number of difference sources, including a host 102 of FIG. 2, a viewer 202 of FIG. 2, and/or a participant 208 of FIG. 2. The received information can include model information from the host 102 of FIG. 2 that is to be rendered by the projector 108.

Furthermore, received information can include information to change rendered information. The reception component 402 can operate in a number of different manners, including wireless communication, wired communication, hybrid communication (e.g., partial wired, partial wireless), etc. In addition, the reception component 402 can configure with various features. For example, the reception component 402 can include a keypad that allows users to login when operating the projector 108.

An identification component 404 determines the source of received information as well as the purpose of the received information. For example, the reception component 402 can receive a request from a viewer 202 of FIG. 2 to modify a rendered image. However, the viewer 202 of FIG. 2 does not have authorization to modify the rendered image. The identification component 404 send information to a processor 406 that the request should not be honored since it is from an unauthorized source.

The processor 406 coordinates functions of the projector 108. Various amounts of information can enter and exit the projector 108 and the processor 406 operates to assure that information executes in a proper manner. While the processor 406 is shown as directly interacting with several components, it is to be appreciated the processor 406 can interact with different component configurations (e.g., interaction with all disclosed components.) The processor can transmit received information to other components in a format that prepares the received information for rendering.

Storage 408 holds records of information relating to operation of the projector 108. The storage 408 can operate in conjunctions with various components disclosed as part of the projector 108. For example, the identification component 404 can send a copy of received requests to the storage 408. The storage 408 can sort information based on what component sent the received information as well as type data for the received information. An amendment component 410 enables alteration of an image from an instruction received from a second remote location.

A check component 412 determines if information from the processor 406 is in a condition for rendering. For example, information transferred from the processor 406 can be insufficient to enact a proper rendering. The check component 412 can operate in several difference manners. According to one embodiment, the check component 412 can attempt to correct and errors in information that is to be rendered (e.g., sampling errors). According to another embodiment, the check component 412 returns information to the processor 406 and the processor attempts to correct the error. In a further embodiment, the check component relays an error message with details concerning the received information.

An override component 414 can function to stop the rendering of specific information. The override component 414 can operate as a filter of information that should not be rendered. For example, various obscenities and derogatory language can be offensive to groups. The override component 414 can block offensive information from being rendered. The override component 414 can automatically block terms or images that are commonly held as offensive.

According to another embodiment, a user can set security policies for the projector 108 that does not allow for a rendering of specific information. For example, the display of some imagery can be illegal in certain locations (e.g., display of Nazi propaganda can be illegal in some European nations). Therefore, the user can instruct the override component 414 to stop attempts to display illegal imagery. The user through the reception component 402 can configure the override component.

A render component 416 takes model information obtained through the reception component 402 and generate an image from the model. Unlike conventional systems, rendering takes place on the projection side. The rendering engine 110 of FIG. 2 can operate as a render component 416. Rendering can include multiple features, including production of an image that possesses shading, reflection, depth, and the like. A rendered image transfers to a display component 420.

A verification component 418 can perform a validation upon a rendered image produced by the render component 418. The render component 416 can make mistakes in rendering an image. The verification component 418 determines if there are errors concerning the rendered image. Depending on possible errors, the verification component 418 can operate in different manners (e.g., correct at least some of the errors, transfer the rendered image to another component capable of correcting the error, distributing an error message, etc.). According to one embodiment, the verification component 418 operates in conjunction with the check component 412. According to another embodiment, the verification component 418 and check component 412 configure together.

The display component 420 presents a rendered image. The display component 420 can be a screen that presents the image, which can include the screen 112 of FIG. 2. However, the display component can project a rendered image onto another surface. The display component 420 can operate in conjunction with a transmission component 420.

The transmission component 420 can emit information concerning operation of the projector. For example, the transmission component 420 can send periodic maintenance reports to a central server. In another example, the transmission component 420 can send information to host 102 of FIG. 2, a viewer 202 of FIG. 2, and/or a participant 208 of FIG. 2 concerning the status of the projector 108. The transmission component 420 can integrate with the reception component 402 to interact with auxiliary components.

The amendment component 410 enables modification of a rendered image from an instruction of another device. For example, a participant 208 of FIG. 2 can transfer an instruction to the projector 108 to modify an image presented on the display component 420. The reception component 402 can receive the instruction and the processor 406 can identify that received information is an instruction. The amendment component 410 can modify the information displayed through utilization of the render component 416. The check component 412, override component 414, and the verification component 418 can all operate upon the amendment component 410 to ensure that proper changes are taking place.

The render component 416 generates an image from information received from a first remote location (e.g., host). The amendment component 410 enables alteration of the image from an instruction received from a second remote location (e.g., participant.) The instruction from the second remote location can arrive directly or indirectly (e.g., passing through a host device for permission.) Remote locations can include local remote locations (e.g., wireless devices communicating in the same conference room), virtual remote locations (e.g., locations spread over the Internet), as well as others.

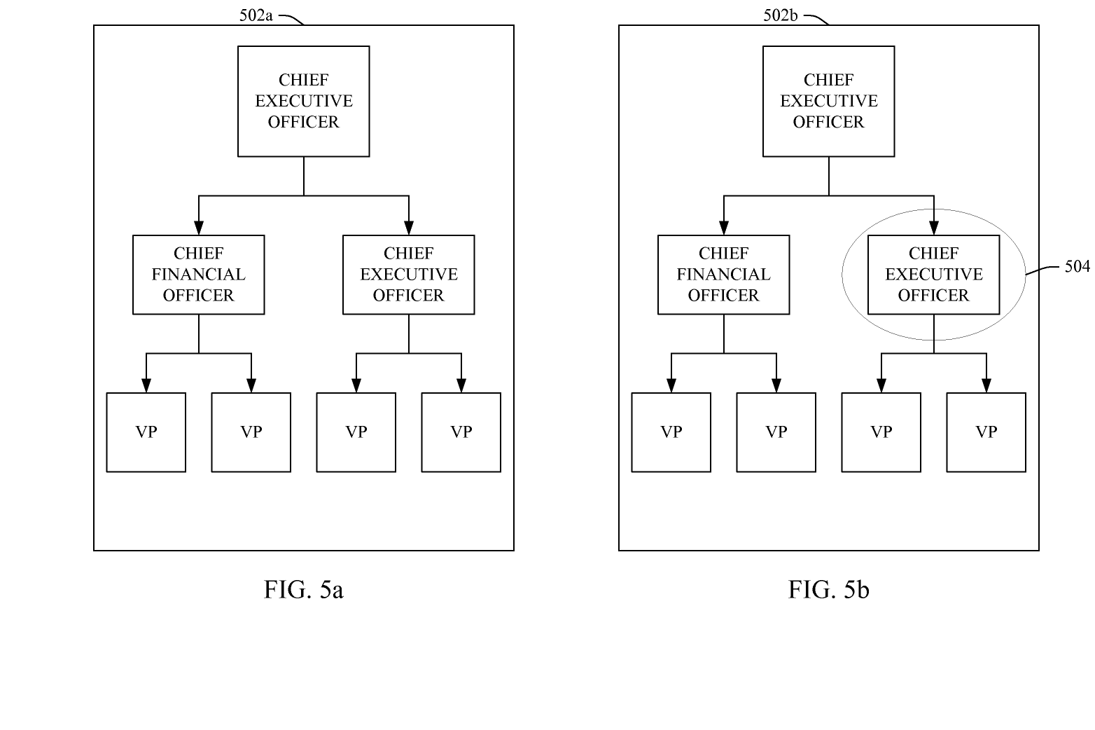

FIG. 5a and FIG. 5b disclose an example interaction of a participant 208 of FIG. 2 upon a screen 112 of FIG. 2. The drawings disclose an example enhancement of what is displayed upon a screen 112 of FIG. 2 (e.g., presentation aids.) FIG. 5a discloses an example slide 502a presented on the screen 112 of FIG. 2. For example, the slide 502a can show a proposed structure of corporate offices for a start-up company.

However, a member of the audience that can engage the participant 208 of FIG. 2 can have a question concerning a specific portion of the slide 502a. For example, an audience member can have a question concerning the ‘Chief Executive Officer.’ To explain the question, it can be beneficial to highlight an area that related to the question. Therefore, the audience member can engage a participant 208 of FIG. 2 and circle 504 a portion of a slide 502b that relates to the question (e.g., slide 502a becomes slide 502b when a modification takes place. The slides are identical except for the circle 504 modification.) The modification can travel to the projector 108 of FIG. 2 where the projector 108 of FIG. 2 displays the modification on the screen 112 of FIG. 2.

According to one embodiment, the participant 208 of FIG. 2 makes a request to a host 102 of FIG. 2 to make the change. This can take place in a number of different formats. In one format, the participant 208 of FIG. 2 makes the request to change the slide 502a without informing the host 102 of FIG. 2 of the proposed change. The proposed change transfers to the projector 108 of FIG. 2 and the projector 108 of FIG. 2 presents the change on the screen.

In another format, the participant 208 of FIG. 2 makes a request to the host 102 of FIG. 2 to make a modification to the slide 502a. However, the host 102 of FIG. 2 requires that there be an approval from a user engaged with the host 102 of FIG. 2 before a modification can take place. Therefore, a proposed modification transfers to the host 102 of FIG. 2 and the host 102 of FIG. 2 presents the proposed modification to a leader (e.g., presenter). The proposed modification can display on a screen integrated with the host 102 of FIG. 2. If the user engaged with the host 102 of FIG. 2 approves of a modification, then the host 102 of FIG. 2 transfers the modification to the projector 108 of FIG. 2 and the modification displays upon the screen 112 of FIG. 2.

In a further format, there can be an informal setting where a requestor that engages a participant 208 of FIG. 2 would like to make a modification. The user engaged with the participant 208 of FIG. 2 can make a verbal request to a presenter to make a modification. The presenter can approve of the modification and send a signal to the host 102 of FIG. 2 to allow a modification from the participant 208 of FIG. 2. The host transfers a signal to the projector 108 of FIG. 2 to allow a modification transferred by the presenter 208 of FIG. 2. Once the projector 108 of FIG. 2 receives the modification, there can be an automatic stop placed on further modifications.

According to one embodiment, screens can be split and thus slide 502a and 502b can be displayed at the same time. For example, during a presentation, ‘person X’ desires to add more information in response to a question asked by ‘person Y.’ ‘Person X’ connects from his laptop to the projector 108 of FIG. 2; the projector 108 of FIG. 2 can allow ‘person X’ access. ‘Person X’ can highlight parts of a side (e.g., slide 502b) to explain a point of information. The projector 108 of FIG. 2 can divide the screen into two halves, one-half for slide 502a and one-half for slide 502b.

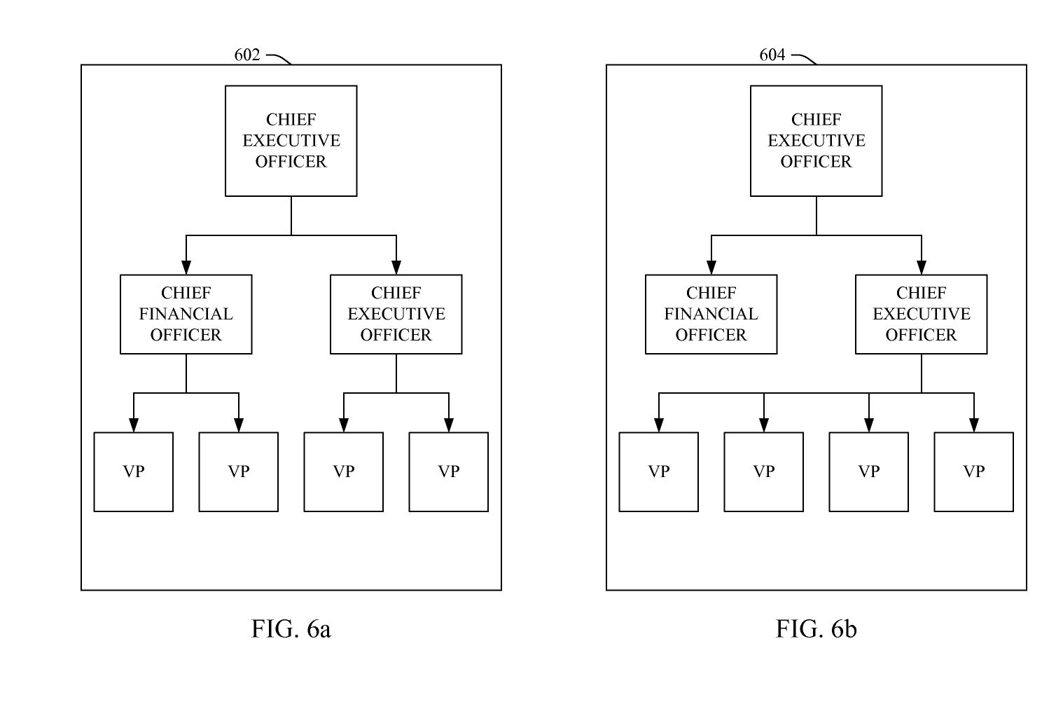

FIG. 6a and FIG. 6b disclose an example interaction of a participant 208 of FIG. 2 upon a screen 112 of FIG. 1. These drawings disclose an example modification of the display of a screen 112 of FIG. 2 (e.g., presentation aids.) The drawings operate in a similar manner to FIG. 5a and FIG. 5b. However, FIG. 5a and FIG. 5b disclose a highlight of information on a slide 502, while FIG. 6a and FIG. 6b disclose a substantive change to the information disseminated in a slide 602.

For example, a slide 602 can be made by the speaker and presented by the host 102 of FIG. 2 that relates to a corporate structure. A difference between the slide 602 and a slide 604 is a change in the subject matter disclosed in the slide 604. The change modifies what was initially presented by the host 102 of FIG. 2. As disclosed in the figures, there is a change in slide 604 in the connection between the second level and third level of the slide 602.

This can operate in a similar manner as disclosed information in FIG. 5a and FIG. 5b. Various permission levels can be set through the host 102 of FIG. 1 and the host 102 of FIG. 1 can implement the permissions. This can include both allowing a participant 208 of FIG. 1 to make a change automatically and/or a host 102 of FIG. 1 requiring a speaker response before allowing the change to the slide 602.

According to one embodiment, there are different polices that regulate between substantive changes (e.g., a slide modification as shown in FIG. 6b) and enhancement changes (e.g., a slide modification as shown in FIG. 5b). For example, to make a substantive change, the participant 208 of FIG. 2 could need permission from the host 102 of FIG. 2 to make the modification. However, for an enhancement change, the modification can take place without permission.

According to another embodiment, there can be a separate policy set depending if there should be a save of the substantive change. For example, implementing a system 200 of FIG. 2, there can be multiple users that integrate with viewers 202 of FIG. 2 and/or participants 208 of FIG. 2. A participant 208 of FIG. 2 can receive from a user a command to change a slide 602. However, a viewer 202 of FIG. 2 could not want to save any changes. For example, a speaker integrated with the host could be a well-known individual in a field that a user integrated with the viewer respects. Therefore, while there is a change for what is viewed, the viewer 202 of FIG. 2 can have local settings regulating saving new information.

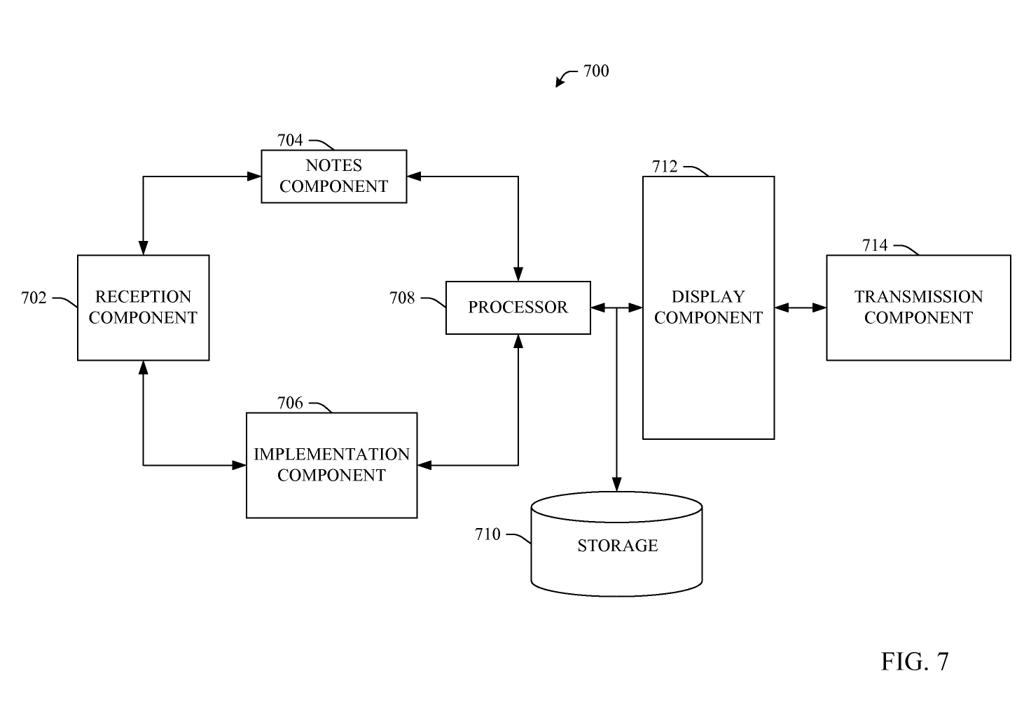

FIG. 7 discloses an example auxiliary device 700 in accordance with an aspect of the subject specification. It is to be appreciated that the auxiliary device could be a viewer 202 of FIG. 2 and/or a participant 208 of FIG. 2. Furthermore, it is to be appreciated that the viewer 202 of FIG. 2 and/or the participant 208 of FIG. 2 can include other components not disclosed.

A reception component 702 obtains information that relates to operation of the device 700. An audience member can input information into the reception component 702. The reception component 702 can operate according to a number of different embodiments. According to one embodiment, the reception component 702 receives information from other devices (e.g., host 102 of FIG. 2, projector 108 of FIG. 2, etc.) through wireless transmission. According to another embodiment, the reception component 702 receives information through a wired configuration. The reception component 702 obtains an image based on information presented on a non-local device (e.g., an obtained image is an image presented by a projector 108 of FIG. 2.) Thus, the local version of the rendered image can be based on an image presented on a non-local device (e.g., a projector 108 of FIG. 2.) Being based on an image can mean the rendered image is an exact replica of a presented image or a similar image to a presented image (e.g., lower quality, black-and-white while the presented image is color, language modification, etc.)

A notes component 704 enables an audience member to modify locally a local version of a rendered image. Commonly, this is for taking at least one note of a presentation (e.g., a live slideshow presentation.) A note can be any supplemental information to the rendered image. This can include adding information to a rendered image (e.g., adding a circle around an image portion, writing text upon an image portion, etc.), removing information of the rendered image (e.g., deleting a portion of the rendered image, etc.), etc. The notes component 704 receives instructions from an audience member on how to change a presentation. For example, a speaker can add context to a visual aid. The audience member can have a desire to write the context on a copy of the visual aid. The notes component 704 enters a local modification to the local copy. Furthermore, the notes component 704 can enable the taking of screenshots of displayed information and the modification of the screenshots. Modified screenshots can be stored in the storage 710.

An implementation component 706 places at least one non-local modification the local version of a rendered image. Other audience members can make changes to rendered image. The implementation component 706 makes the changes of the other audience member on the local copy. This allows an audience member that engages the device 700 to take notes and have the local copy change in accordance with approved changes.

A processor 708 coordinates functions of the device 700. Various amounts of information can enter and exit the device 700 and the processor 708 operates to assure that information executes in a proper manner. While the processor 708 is shown as directly interacting with several components, it is to be appreciated the processor 708 can interact with different component configurations (e.g., interaction with all disclosed components.) The processor 708 could function as the projector driver 206 of FIG. 2 and/or function as the project driver 212 of FIG. 2. Thus, the processor 708 can render received information as well as modification information.

Storage 710 retains a copy of the local version of the rendered image. When the notes component 704 and/or the implementation component 706 operate, operation is commonly upon a copy saved in the storage 710. The processor 708 can also utilize information located in the storage 710 when performing an operation. Storage 710 can function as a means for storing the local version of the rendered image with a modification.

A display component 712 presents the local version of the rendered image. The display component 712 can present the local version of the image. The display component can integrate into the device 700 or attach separately. The display component 712 can represent the screen preview 204 of FIG. 2 and/or the screen component 210 of FIG. 2.

A transmission component 714 sends a modification for the rendered image. Regardless if the device 700 functions as a viewer 202 of FIG. 2 or a participant 208 of FIG. 2, transmissions can be sent from the device 714 for modifying the rendered image. The applicability of a proposed change (e.g., if the proposed change is accepted) is non-dependent on the transmission component 714 sending out a message. The reception component 702 and the transmission component 714 can integrate together to form one component.

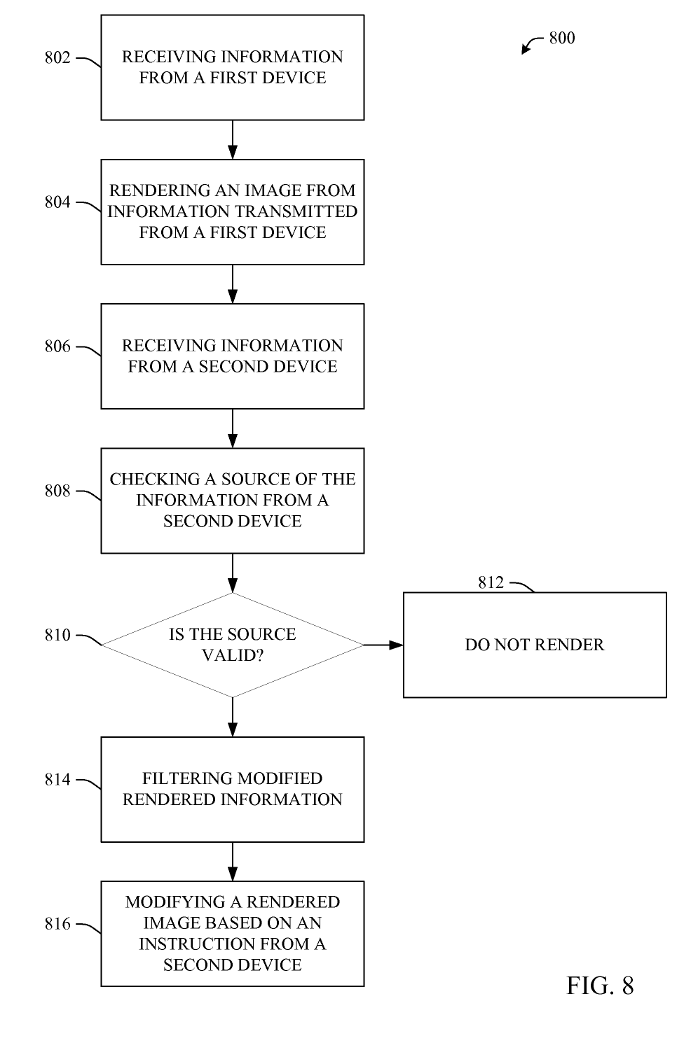

FIG. 8 discloses an example methodology 800 regarding note taking by an audience member (e.g., a viewer 202 of FIG. 2, a participant 208 of FIG. 2, etc.) A first device can transmit information and there is receiving of information from a first device 802. Received information is commonly model information that cannot yet be rendered without further processing. There is rendering an image from information transmitted from a first device 804. Action 804 converts model information into an image that can be viewed.

Information can be received from a second device 806. Information received in act 806 commonly pertains to modification of rendered information. For example, information received can attempt to make a change similar to what was disclosed in FIG. 5b and/or FIG. 6b. To assure that there should be a modification, there can be a checking a source of the information from the second device 808. According to one embodiment, some sources can make modifications while other source cannot make modifications. Checking assists in assuring that modification derive from sources that have permission to make changes.

Once the source is checked, there can be an action 810 to determine if the source is valid (e.g., if the source has permission to make a modification on rendered information.) If the source is not valid, then there should be no rendering of the modification. If the source is valid, then there should be filtering of modified rendered information 814. A filter can make sure inappropriate content is not displayed. Finally, there is modifying rendered information based on an instruction from a second device 816. This changes rendered information in accordance with the instruction from the second device.

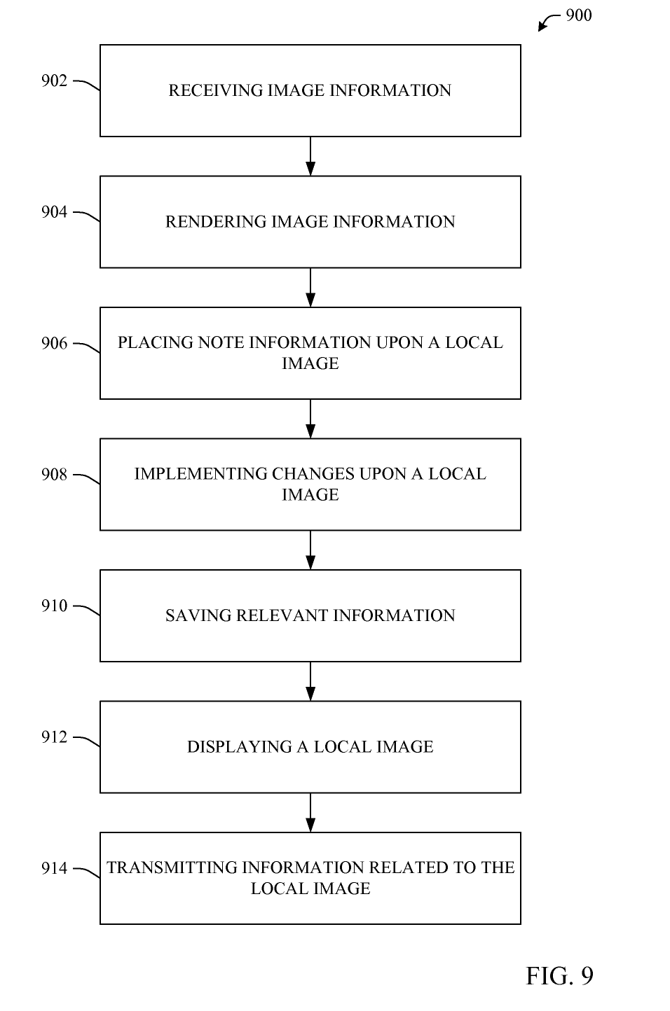

FIG. 9 discloses an example methodology 900 for operating upon a local image. Information is received from an auxiliary location 902. Commonly, a local device that implements the methodology 900 can receive image information from a host or a projector. Typically, rendering takes place at the local device, so there is rendering of image information 904.

A user who engages a device operating the methodology 900 can attempt to take notes upon a rendered image. There can be placing note information upon a local image 906. In addition, there can be changes to a parent image that relates to a rendered image at a local site. Therefore, there can be implementing changes upon a local image 908.

There can be saves made of relevant information 910. Relevant information can encompass a wide range of information, including notes take and implemented changes. There can be periodic saves and/or saves when information is received from a user that a save should take place. The local image can be displayed 912, which can include at least some rendering. Furthermore, there can be a transmission of information relating to the local image 914 (e.g., a confirmation that the local image successfully appears on a device operating the methodology 900.)

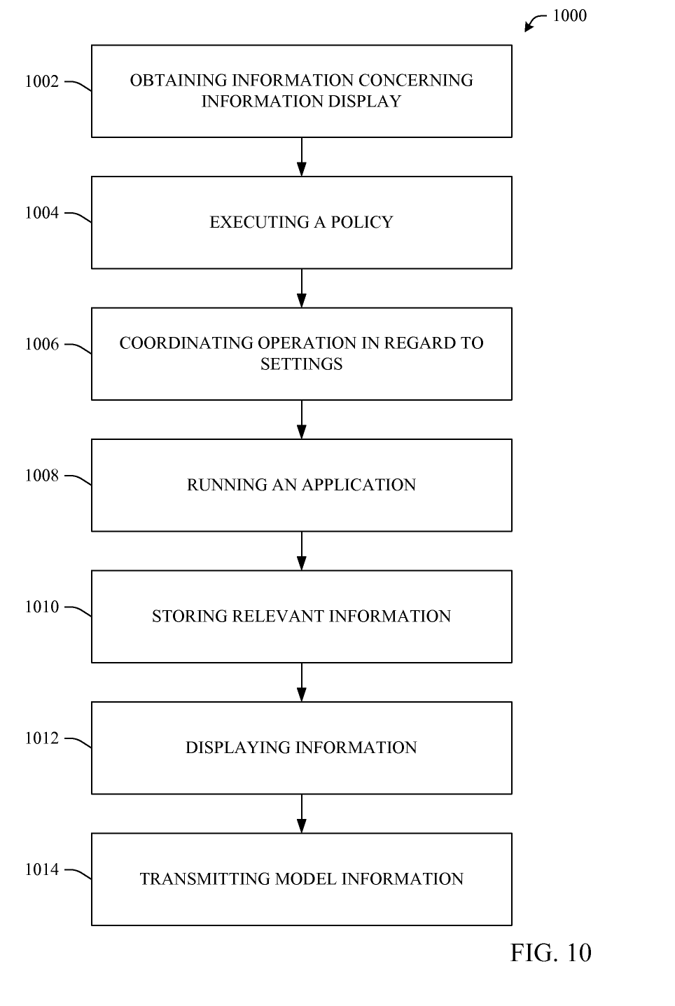

FIG. 10 discloses an example methodology 1000 for image transfer on a host side. There is obtaining of information concerning information display 1002. For example, a user can input imagery that is to be displayed. Individuals approved through a policy can change inputted imagery. In order to approve the individuals, there should be executing of at least one policy 1004.

There can be coordinating of operations in regards to settings 1006. For example, a user operating a device implementing the methodology 1000 can desire for an image to be displayed at a particular resolution. Therefore, a setting can be coordinated that the resolution should be a fixed amount. An application can be run 1008 that prepares an image for rendering.

There can be storage of relevant information 1010. Relevant information can be an array of information pieces, including a back-up copy of inputted imagery, copy of work performed through the application, etc. Imagery can be displayed 1012 that can include at least some rendering. Model information can be transmitted 1014, where a projector can render the model information into a presented image.

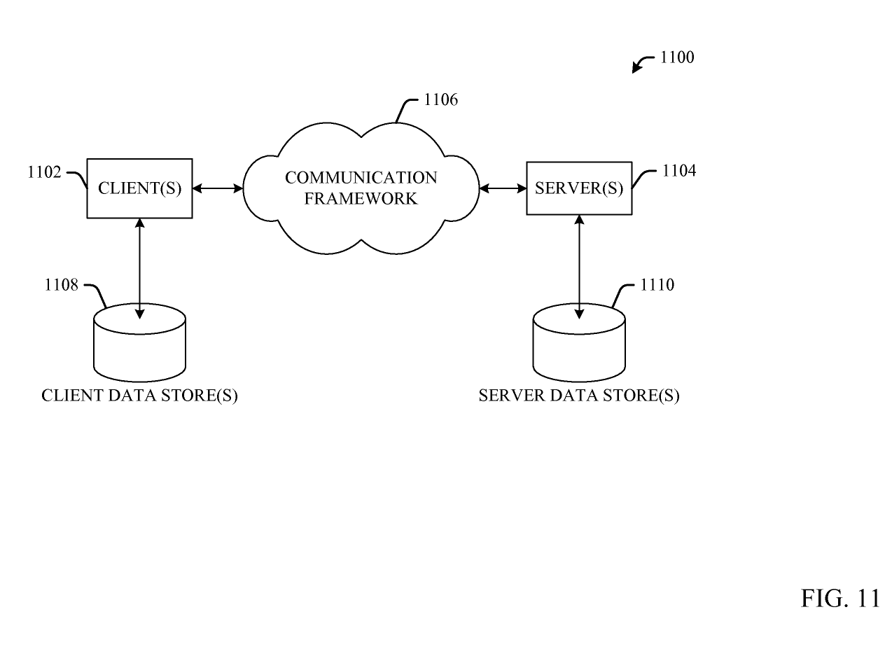

Referring now to FIG. 11, there is illustrated a schematic block diagram of a computing environment 1100 in accordance with the subject specification. The system 1100 includes one or more client(s) 1102. The client(s) 1102 can be hardware and/or software (e.g., threads, processes, computing devices). The client(s) 1102 can house cookie(s) and/or associated contextual information by employing the specification, for example.

The system 1100 also includes one or more server(s) 1104. The server(s) 1104 can also be hardware and/or software (e.g., threads, processes, computing devices). The servers 1104 can house threads to perform transformations by employing the specification, for example. One possible communication between a client 1102 and a server 1104 can be in the form of a data packet adapted to be transmitted between two or more computer processes. The data packet may include a cookie and/or associated contextual information, for example. The system 1100 includes a communication framework 1106 (e.g., a global communication network such as the Internet) that can be employed to facilitate communications between the client(s) 1102 and the server(s) 1104.

Communications can be facilitated via a wired (including optical fiber) and/or wireless technology. The client(s) 1102 are operatively connected to one or more client data store(s) 1108 that can be employed to store information local to the client(s) 1102 (e.g., cookie(s) and/or associated contextual information). Similarly, the server(s) 1104 are operatively connected to one or more server data store(s) 1110 that can be employed to store information local to the servers 1104.

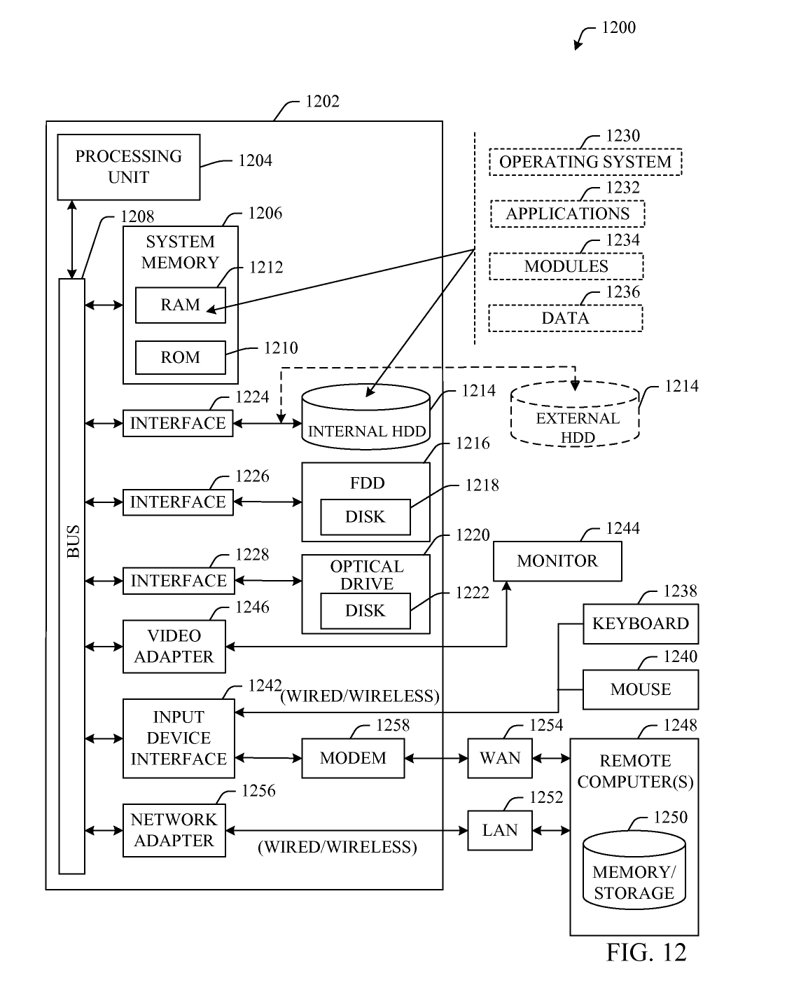

Referring now to FIG. 12, there is illustrated a block diagram of a computer operable to execute the disclosed architecture. In order to provide additional context for various aspects of the subject specification, FIG. 12 and the following discussion are intended to provide a brief, general description of a suitable computing environment 1200 in which the various aspects of the specification can be implemented. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 12, the example environment 1200 for implementing various aspects of the specification includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures may also be employed as the processing unit 1204.

The system bus 1208 can be any of several types of bus structure that may further interconnect to a memory bus (with or without a memory controller), a peripheral bus, and a local bus using any of a variety of commercially available bus architectures. The system memory 1206 includes read-only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1202, such as during start-up. The RAM 1212 can also include a high-speed RAM such as static RAM for caching data.

The computer 1202 further includes an internal hard disk drive (HDD) 1214 (e.g., EIDE, SATA), which internal hard disk drive 1214 may also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the specification.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is appreciated that the specification can be implemented with various commercially available operating systems or combinations of operating systems.

A user can enter commands and information into the computer 1202 through one or more wired/wireless input devices, e.g., a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 1394 serial port, a game port, a USB port, an IR interface, etc.

A monitor 1244 or other type of display device is also connected to the system bus 1208 via an interface, such as a video adapter 1246. In addition to the monitor 1244, a computer typically includes other peripheral output devices (not shown), such as speakers, printers, etc.

The computer 1202 may operate in a networked environment using logical connections via wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wired/wireless connectivity to a local area network (LAN) 1252 and/or larger networks, e.g., a wide area network (WAN) 1254. Such LAN and WAN networking environments are commonplace in offices and companies, and facilitate enterprise-wide computer networks, such as intranets, all of which may connect to a global communications network, e.g., the Internet.

When used in a LAN networking environment, the computer 1202 is connected to the local network 1252 through a wired and/or wireless communication network interface or adapter 1256. The adapter 1256 may facilitate wired or wireless communication to the LAN 1252, which may also include a wireless access point disposed thereon for communicating with the wireless adapter 1256.

When used in a WAN networking environment, the computer 1202 can include a modem 1258, or is connected to a communications server on the WAN 1254, or has other means for establishing communications over the WAN 1254, such as by way of the Internet. The modem 1258, which can be internal or external and a wired or wireless device, is connected to the system bus 1208 via the serial port interface 1242. In a networked environment, program modules depicted relative to the computer 1202, or portions thereof, can be stored in the remote memory/storage device 1250. It will be appreciated that the network connections shown are example and other means of establishing a communications link between the computers can be used.

The computer 1202 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An image projection system, comprising:
a render component that generates an image from information received from a first remote location; and
an amendment component that enables alteration of the image from an instruction received from a second remote location.

2. The system of claim 1, further comprising an override component that blocks presentation of the generated image based on the content of the generated image.

3. The system of claim 1, further comprising a check component that determines a condition of information received from a remote location.

4. The system of claim 1, further comprising a processor that coordinates operations for generation of the image.

5. The system of claim 1, further comprising a reception component that obtains information from the remote location.

6. The system of claim 1, further comprising a storage component that retains information related to the generated image.

7. The system of claim 1, further comprising a transmission component that emits data concerning the generated image.

8. The system of claim 1, further comprising an identification component that determines the character of the remote location.

9. The system of claim 1, further comprising a verification component that checks consistency between pre-rendered information and rendered information.

10. A method, comprising:
rendering an image from information transmitted by a first device; and
modifying a rendered image based on an instruction from a second device.

11. The method of claim 10, further comprising checking a source of the instruction from the second device.

12. The method of claim 10, further comprising filtering modified rendered information.

13. The method of claim 10, further comprising storing a copy of rendered information.

14. The method of claim 10, further comprising receiving information from the first device.

15. The method of claim 10, further comprising receiving information from the second device.

16. A system for taking at least one note, comprising:
means for modifying a local version of a rendered image; and
means for storing the local version of the rendered image with a modification, wherein the local version of the rendered image is based on an image presented on a non-local device.

17. The system of claim 16, further comprising means for implementing at least one non-local modification upon the local version of the rendered image.

18. The system of claim 16, further comprising means for presenting the local version of the rendered image.

19. The system of claim 16, further comprising means for receiving information that pertains to at least one non-local modification of the local version of the rendered image.

20. The system of claim 16, further comprising means for transmitting a modification for the rendered image.
